(19) United States
(12) Patent Application Publication
(10) Pub. No.: US 2002/0094072 A1
(43) Pub. Date: Jul. 18, 2002

(54) Virtual remote office

(76) Inventors: William Evans, Tarzana, CA (US); Gilda Evans, Tarzana, CA (US)

Correspondence Address: OPPENHEIMER WOLFF & DONNELLY LLP, 2029 CENTURY PARK EAST, 38TH FLOOR, Los Angeles, CA, 90067-3024, US

(21) Appl. No.: 09/760,436

(22) Filed: Jan. 12, 2001

(51) Int. Cl. H04M 1/66; H04M 3/42

(52) U.S. Cl. 379/199; 379/201.03

(57) ABSTRACT

The virtual remote office of the present invention includes a programmable processor within a portable housing and a communications connection for transmitting communications between the virtual remote office and an external communications network. The processor is programmed to restrict incoming and outgoing communications, disconnect a telecommunications path between the virtual remote office and an external communications network, and redirect incoming communications to another line. In addition to the processor, the circuitry within the portable housing includes a Data Access Arrangement and line status module, a switching module, an off-hook detection module, a DTMF decoder module, and a light emitting diode module.

### BACKGROUND OF THE INVENTION

The invention relates generally to telecommunications systems, and more particularly to portable and programmable telecommunications system.

Telephonic communications are an essential part of the home and business environments. Telephone companies provide homes and businesses with custom features to make their telephone systems more useful, convenient and secure. However, these customized features are limited to a specific home or business location and usually do not travel with the user. Additionally, the available features can be expensive and are limited to those provided by the telephone company. A further drawback to existing telephone systems is that adding or deleting features or modifying the telephone company's existing features can be inconvenient or even impossible.

### SUMMARY OF THE INVENTION

A general object of the present invention is to provide a portable and programmable telecommunications control and data storage device, or Virtual Remote Office (“VRO”). The VRO provides control over business and personal communications in one small, economical, portable and programmable package.

The VRO is used in environments ranging from residences, small offices, restaurants, copy centers, hospitality suites, to corporate lobbies of larger enterprise operations for executives and sales personnel. The VRO is small and light so that it can easily be taken along when traveling. For example, on a typical business trip the VRO can be taken from the home office, attached to an airport pay telephone while waiting for an airplane, attached to the onboard airplane telephone, then attached to the hotel telephone after arriving at a destination. Finally, upon arrival at a clients office or a branch office, the VRO can be attached to those telephones. Adding even more versatility, the VRO can be attached to a cellular telephone as well. Thus, it is as if one is making telephone calls from the home office, even when away from the home office. Among other applications, the VRO is useful for restricting outbound or incoming calls for one or more telephone extensions, for disconnecting a telephone extension when not in use for security purposes, or for redirecting incoming calls to another extension or line.

A typical application for the VRO is in the lobby of a large corporation. It is connected to the hospitality telephone to restrict outgoing calls to local calls only. However, executives who have a special code number can use the telephone in an unrestricted fashion. Further, executives and sales personnel who have use of a special code can call this extension from the outside and use it to place calls to other extensions or to numbers inside or outside the company's telephone system. The lobby telephone is disconnected from dial tone while being used by an outside party. The memory of the VRO can be downloaded to the company's computer system making a convenient report of all calls made.

Another application of the VRO is in the homes of parents with talkative children or teenagers. When connected to the child's telephone, the VRO only allows calls to certain numbers and keeps track of all incoming and outgoing calls. The child's telephone is disconnected from the dial tone until either an authorized call comes in or until an authorized outbound number is entered.

For those worried about security, the security disconnect feature disables the dial tone when the telephone is not in use, effectively disabling any type of listening device which might have been placed on the telephone line or placed to use the telephone itself as a monitor.

More generally, the present invention provides a portable and programmable telecommunications control and data storage device comprising a communications connection for transmitting telephonic communications between the telecommunications control and data storage device and an external communications network; a portable housing containing a programmable processor, a storage device, and a switching module electrically connected between a telephonic terminal and the communications connection; and multiple programs stored by the storage device, at least one of the programs executed by the processor to control the switching module to disconnect the terminal from the communications connection while maintaining the connection between the terminal and the telecommunications control and data storage device.

Also, in general, the method of using the present invention includes the steps of picking up a telephone connected to the virtual remote office but physically disconnected from any telephone line; speaking a code or pressing a telephone keypad to enter a code to connect the telephone to a telephone line; and upon connection to the telephone line, dialing an outside telephone number.

These objects as well as other objects, features and advantages of the invention will become more apparent to those skilled in the art from the following description with reference to the accompanying drawings.

### BRIEF DESCRIPTION OF THE DRAWINGS

Detailed description of the preferred embodiment of the invention will be made with reference to the accompanying drawings.

FIG. 1 is a diagrammatic perspective view of the VRO connected to a telephone line, an electric outlet, and to peripheral devices.

FIG. 2 is a semi-diagrammatic circuit diagram of a circuit for implementing the Virtual Remote Office of FIG. 1.

FIG. 3 is a semi-diagrammatic circuit diagram of a processor module used by the circuit of FIG. 2.

FIG. 4 is a functional block diagram showing operating blocks of the Virtual Remote Office of FIG. 1.

### DETAILED DESCRIPTION OF THE PREFERRED EMBODIMENTS

Disclosed herein is a detailed description of the best presently known modes of carrying out the invention. This description is not to be taken in a limiting sense, but is made merely for the purpose of illustrating the general principles of the invention. The overall organization of the present detailed description is for the purpose of convenience only and is not intended to limit the present invention.

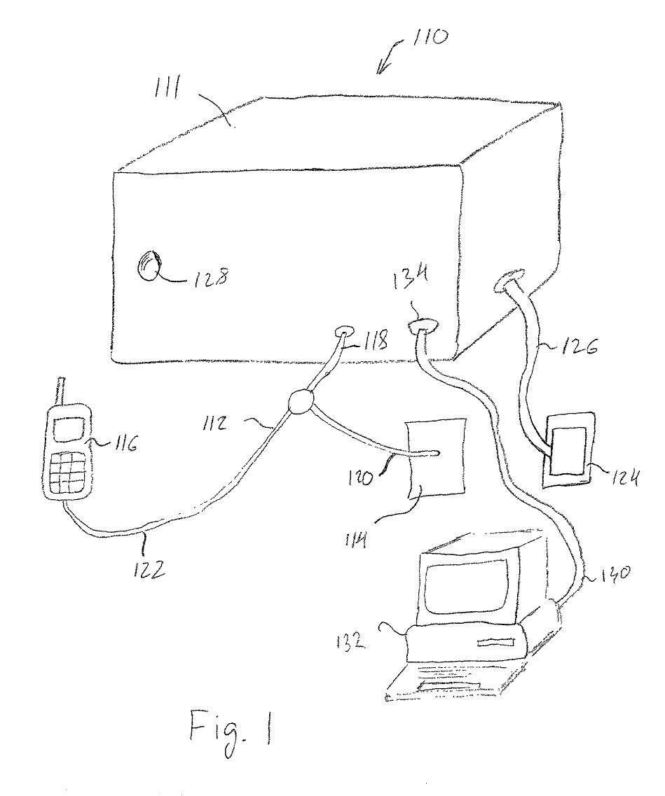

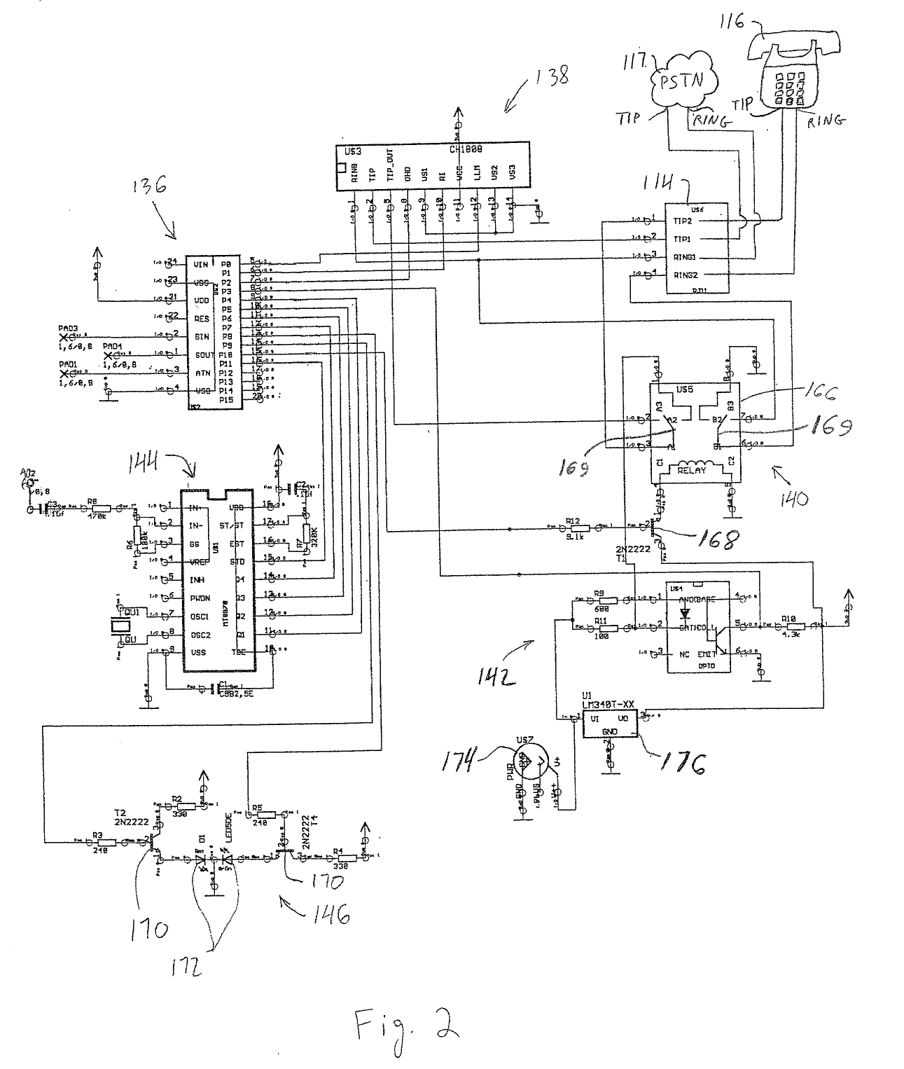

FIG. 1 is a diagrammatic view of a Virtual Remote Office (“VRO”) 110. The VRO 110 has a housing 111, which can have a compact size and the overall unit can be lightweight so as to make the VRO 110 easily transportable by an individual. For example, the volume of the housing 111 can be less than ⅓ cubic meters and the overall weight can be less than 1 kilogram so that it can easily be carried from one location to another. A telephone cord 112 has three connectors and is used to connect the VRO 110 to a telephone wall jack 114 and to a telephone 116. The telephone wall jack 114 can lead to a Public Switched Telephone Network (“PSTN”) 117 as illustrated in FIG. 2. To simplify correct hook-up, the telephone cord 112 can have a red end 118 for connection to the VRO 110, a white end 120 for connection to the telephone wall jack 114 and a black end 122 for connection to the telephone 116. Power can be provided from an electrical wall outlet 124 through an electrical cord or wall transformer 126, or can be provided by a battery pack (not shown). Of course, in other embodiments the VRO 110 can be connected to other telecommunications networks instead of, or in addition to, the PSTN. For example, the VRO 110 can be connected to Private Business Exchanges (“PBE”). Also, rather than using the telephone cord 112, connections can be made utilizing microwave or optical connections or other types of communications connections.

When installing the VRO, the red end 118 is connected to the VRO 110, the black end 122 is connected to the telephone 116, the white end 120 is connected to the telephone wall jack 114 and the appropriate connections are made to supply power, from the wall outlet 124 or battery pack, for example.

Rather than, or in addition to, connecting the telephone 116 to the telecommunications network, other terminals or peripherals can be connected. Here, a terminal is a device capable of sending and/or receiving information over a communications channel. For example, the VRO 110 can be used to connect another telephonic terminal such as a modem, a telefax terminal, or an answering machine to the telecommunications network.

The various operating stages of the VRO 110 can be indicated, for example, by an LED 128 providing continuous or flashing red, green or orange light.

A cable 130 connects a computer 132 to the VRO 110 via a computer port 134. The port can be a USB, PCMCIA, EIA-232 or other type of port and can use a 9-pin D-type connector (“DB-9”) or other type of connector. The port can be used to add the functions described in the instant specification to the VRO 110 or can be used to allow additional updated functions to the VRO 110 as needed. The computer 132 can be a personal computer, a computer network or other external data processing system.

The VRO 110 can be used to control a single extension by connecting it to the single extension RJ11 telephone jack. Multiple VROs can be utilized to control multiple telephone extensions by attaching a separate VRO to each extension. A single VRO 110 can also be used to control multiple telephone extensions. To accomplish this, an RJ-45 telephone jack, installed at the Minimum Point of Entry (“MPOE”), serves as the telephone wall jack 114. To set up this type of installation, incoming telephone service is wired to pair 1 (red/green) and the telephones are wired to pair 2 (yellow/black). All telephones connected to the same telephone line can then be controlled by the same VRO 110. Additionally, another embodiment of the VRO 110 can control multi-line telephones.

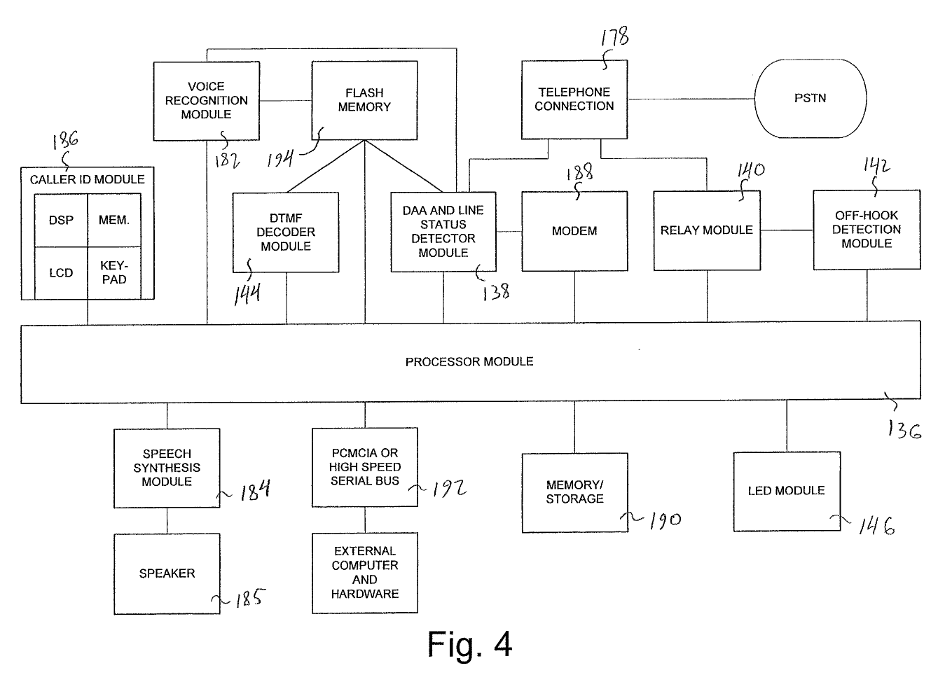

FIG. 4 is a is a functional block diagram showing operating blocks of the VRO and FIG. 2 is a semi-diagrammatic circuit diagram of a circuit for implementing some of the functional blocks of FIG. 4. The circuit includes several major modules: a processor module 136, a Data Access Arrangement (“DAA”) and line status detector module 138, a disconnect or switching module 140, an off-hook detection module 142, a DTMF decoder module 144, and a light emitting diode (“LED”) module 146.

The Data Access Arrangement (“DAA”) and line status detector module 138 can be a CERMETEK CH-1808 line status detector or other custom designed, FCC approved DAA interface. The switching module 140 includes a telephone disconnect relay 166 and a transistor circuit 168, biased by resistors, for driving the relay 166. The relay 166 can be a 5-volt DPDT relay and the transistor 168 can be a 2N2222. The off-hook detection module 142 can utilize a 4N26 optoisolator. The DTMF decoder module 144 can be a MITEL MT8870. The light emitting diode (“LED”) module 146, like the switching module 140, includes transistor circuits 170, which can be of type 2N2222, and which are biased by resistors. LEDs 172 can be standard tricolor diodes. Also included is a power connector 174 attached to a voltage regulator 176. The voltage regulator 176 can be an LM340T. The telephone jack 114 can be a PC mount RJ11 telephone jack.

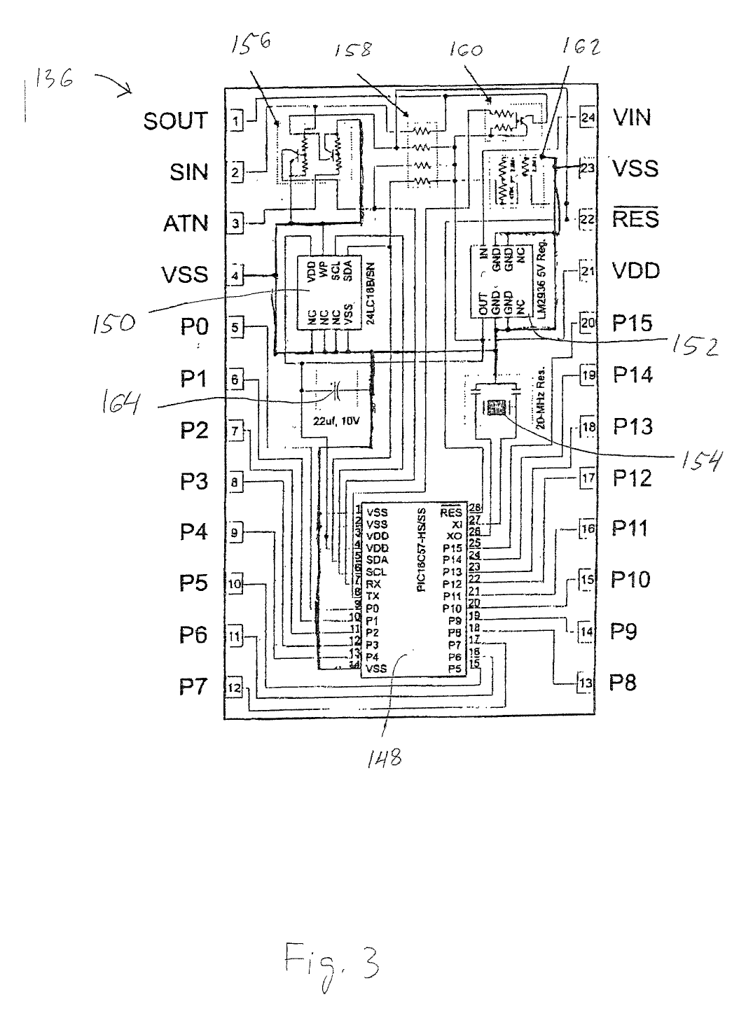

One embodiment of the processor module 136 is shown in greater detail in FIG. 3. The processor module 136 is comprised of surface-mount components and includes a processor 148, a memory 150, a regulator 152, a resonator 154 and several resistor/transistor packs. The processor 148 can be a MICROCHIP PIC 16C57-HS/SS microprocessor, the memory 150 can be a 24LC16B/SN serial memory chip, the regulator 152 can be a LM2936 5-volt regulator, and the resonator 154 can be a 20 MHz ceramic resonator. The illustrated resistor/transistor packs include a dual NPN transistor/resistor pack (10 k-ohm resistors and 2n3904 transistors) 156, a quad resistor pack (4.7 k-ohm resistors) 158, and a single PNP transistor/resistor pack (10 k-ohm resistors and a 2n3906 transistor) 160. Also included is a 4-volt brown-out detector 162 utilizing a 2n3906 transistor. A 22-microfarad, 10-volt tantalum capacitor 164 is connected to the memory 150. The processor 148 can also be a special type, called a Digital Signal Processor (“DSP”), so that it can process data in many different forms, including speech. The memory 150 can be separate from or included in a memory/storage module 190 (FIG. 4) which can be either internal or external to the processor module 136. The memory/storage module 190 can be a semiconductor chip, hard drive, floppy drive, bubble memory or other suitable device.

The processor module 136 has 16 input/output pins. The input/output pins are configured as either inputs or outputs at program startup. Pins P0-P2 supply inputs from the DAA interface and line status detector module 138. Pin P3 supplies input from the off-hook detection module 142. Pins P4-P7 and P11 supply inputs from the DTMF decoder module 144. Pins P8 and P9 supply outputs to the LED module 146 and a pin P10 supplies an output to the switching module 140. The processor module 136 additionally has connections ATN, SIN and SOUT leading to an external computer's DB-9 connector. Rather than using a DB-9 connector, other or additional computer connectors can be used to attach to external computing or peripheral equipment.

FIG. 4 illustrates several modules and components, including their electrical connections, not illustrated in FIG. 2. More specifically, FIG. 4 additionally illustrates a voice recognition module 182, a speech synthesis module 184, a speaker 185 connected to the speech synthesis module 184 a Caller ID module 186, a modem 188, a memory/storage module 190, a PCMCIA, high-speed serial bus, USB, or EIA RS-232, denoted by 192 and a memory 194. The Caller ID module 186 includes a digital signal processor (“DSP”), a memory, a liquid crystal display (“LCD”) and an entry keypad. The voice recognition module can be a SENSORY RSC-364 29XE020. The memory 194 can be a 29xE020 flash memory.

The PCMCIA or high speed serial bus 192 allows the VRO 110 to be connected to the external computer 132, hardware enhancements, specialized modules, printing devices, logging devices or other peripherals though the computer port 134 and the cable 130.

The modem 188 attaches to the processor module 136 and the DAA and line status detector module 138. By using the modem 188 to call a central applications download server, the VRO 110 can immediately retrieve and execute a particular application, download internet-based updates, or download a library of downloadable custom and canned applications and updates. Alternatively, the download server can call the VRO 110 when new applications and updates are available and initiate downloads by providing the VRO 110 with a four-digit security access code. The VRO 110 can also receive new applications and updates through a local computer attached to the PCMCIA or high speed serial bus 192. In such an embodiment, the computer first receives the new application or update and then transfers it to the VRO 110. The server, local computer and VRO 110 can communicate using standard Application Programming Interface (“API”) or Command Language. Applications programs can be stored by the memory/storage module 190 for execution by the processor module 136, or can be executed by the processor 136 directly form the site accessed by the modem or from the external computer.

The VRO circuit has several important functions which, combined together allow the VRO 110 to perform a wide variety of useful applications. The circuit can, for example, disconnect a telephone extension, restrict outbound or incoming calls, or redirect incoming calls. The processor module 136 controls these functions.

The processor module 136 performs the disconnect function by controlling the telephone disconnect relay 166 to cause a physical break between the telephone 116 and the telephone line leading to the PSTN 117. When a single VRO 110 is used to control multiple telephone extensions of a telephone line, as described above, a physical break is created between all of the telephones and the telephone line. When the break is formed between the telephone and the telephone line, no dial tone is heard if the telephone handset is lifted. More specifically, turning to FIG. 2, when the relay 166 is not actuated, armatures 169 form a connection between A1/A2 and B1/B2 (both armatures deflect towards the center), so that the off-hook detection module 142 is connected to the telephone and the telephone 116 is disconnected from the telephone line. When the relay 166 is actuated, the armatures 169 form a connection between A1/A3 and B1/B3 (both armatures deflect out). In this position, the tip and ring connections of the telephone 116 are connected to the tip and ring connections of the PSTN 117 through the DAA and line status detector module 138.

The purpose of the off-hook detection module 142 is to tell the processor when someone has picked up the telephone (or other terminal) 116. Only if, and when, necessary, the relay 166 connects the telephone 116 to the incoming telephone line, thereby answering the phone or issuing a dial tone. The VRO 110 is programmed to identify an incoming ring signal on the incoming telephone line, which then activates the relay 166 to connect the telephone to the telephone line if the source of the call matches an authorized incoming call criteria.

The off-hook detector module 142 also supplies power to the telephone 116 through the voltage regulator 176 when the relay 166 disconnects telephone 116 from power supplied through the telephone lines. This allows the telephone 116 to be used to provide touch tone and spoken commands (for programming the VRO 110, for example) to the VRO 110 when the telephone 116 is disconnected from the telephone line.

When restricting outgoing calls, the processor module 136 performs the disconnect function until an authorized call is placed or until a special code is entered. Whether or not a call is restricted is programmed into the VRO by someone who has a 4-digit code that enables making changes to the telephone call selection criteria. When a call is restricted the telephone line remains disconnected from the telephone. When a call is approved the telephone line is connected to the telephone and the call proceeds normally. The user receives an audible indication as to whether the call was approved or not.

To restrict outgoing, long-distance calls, the following procedure can be used. For security, when the telephone is first picked up, the telephone is disconnected from the telephone line by the switching module and no dial tone sounds. When manually dialing, each digit is dialed, and the VRO 110 sounds out a short beep or voice prompt sounds indicating that each digit is being saved in the VRO's memory. Upon finishing the entry of the telephone number the “#” key is pressed and, if that number is not restricted, the VRO 110 dials the number. If a restricted telephone number is dialed, then a long beep sounds, indicating that the call won't go through.

To get a dial tone before entering the telephone number, a 4-digit security code must first be entered, followed by the “#” key. This security feature assures that only people with the code number can circumvent the restricted call feature. The initial default password is “1234”. To change the 4-digit code, the sequence “*1234*#<new code>#” is entered. Any number can then be dialed freely. To cancel an entered telephone number the “*” key is pressed and then the correct number is re-entered. To cancel a call in progress, the telephone is hung up, as with normal telephone operation.

By default the VRO 110 is programmed to restrict all calls starting with a 1+area code. To allow or disallow calls to certain area codes the following procedure can be used. For example, to allow toll-free “800” number calls, for example, the telephone is picked up and the sequence “*1800*”+“4 digit access code” is dialed, and then the telephone is hung up. To disallow 900 numbers the telephone is picked up and the sequence “#1900#”+“4 digit code” is dialed and then the telephone is hung up. Area codes are “boxed” in “*1”+“area code*” are allowed and area codes “boxed” in “#1”+“area code#” are disallowed.

The modules work together to restrict an outgoing telephone call. After the telephone and telephone line are plugged into the VRO 110 and the unit is powered on, the telephone line status detector module 138 is the first module to be polled. Through logic levels at its outputs, the status of the telephone line is detected, i.e. line idle, ringing, etc. Most of the time the telephone is disconnected from the line voltage and from the telephone line status detector module 138. Therefore, the processor polls the off-hook detection module to determine if the telephone is off hook. If the telephone is off hook, the DTMF decoder module 144 waits for tones of the user-entered code. If the right code is entered, the switching module 140 is activated, thereby giving a dial tone. The LED module 146 provides a continuous or flashing, red, green or orange indication for each stage of VRO 110 operation.

When restricting incoming calls, the processor module 136 performs the disconnect function until an authorized call is received or until a special code is entered. The processor module 136 makes use of the telephone service provider's Caller ID service and the Caller ID module 186 to determine the telephone number from which the incoming call is being received. The processor can compare the incoming number to a telephone book database stored in the memory/storage module 190 to determine if the number is authorized. If it is an authorized telephone number, or at least is not an unauthorized telephone number, the processor triggers the switching module 140, connecting the telephone line so that the telephone call can be received. Alternatively, a user can enter an appropriate 4-digit code to disable the restricting incoming calls feature. Also, 4-digit codes can be programmed to only disable the restricting incoming calls feature for certain incoming telephone numbers.

The processor module 136 performs the redirecting of incoming calls function by using the DTMF decoder module 144 to listen for an appropriate 4-digit code to be entered on all incoming calls. For this application, it is desirable to use a telephone extension that does not normally receive other incoming calls. If the DTMF decoder module 144 detects an appropriate 4-digit code during an incoming call, a voice menu or tone prompts the caller for a command and the processor module 136 triggers the switching module 140 to disconnect the telephone line from all attached telephones. The incoming caller can then use the telephone line to place outgoing calls using the “conference calling” or “3-way calling” features that the telephone company provides. Any number of outgoing calls may be placed using the same incoming call.

The VRO 110 can be connected to a telephone line that has incoming “800” number service with the conference-calling feature enabled. This will allow the “800” number to be called from any remote telephone and the VRO 110 acts as an “operator” for outgoing calls. The use of the “800” number service is highly beneficial because “800” calls are very inexpensive and can be placed from almost anywhere, while being billed to the home base telephone line. All redirected outgoing calls are then billed at the rate they would normally be charged at if the calls were actually placed by someone at the home base. A database of all redirected calls can be created and stored in the memory storage module 190. Again, a call report can later be generated at the user's convenience by connecting the VRO to a PC and accessing the memory module 190.

When operating in the incoming call redirect mode, the processor module 136 causes the DAA and line status detector module 138 to pick up the call upon detection of the first ring. A confirmation tone is produced indicating that the caller must enter a 4-digit access code. Once the code is entered correctly, the unit will forward calls. The number to be called is entered, followed by the “#” key. Pressing the “*” allows the code to be reentered. Once the “#” key is depressed, the VRO 110 places the call. The call is terminated by either hanging up or entering the 4-digit code again. If code is entered again to terminate the call, the VRO gives the confirmation tone again and is ready to place another call. The default 4-digit access code is “1234”. To change it, the telephone attached to the VRO 110 is picked up and the sequence “*1234*#<new code>#” is pressed. For example, to change the code to “2345”, “*1234*#2345#” is pressed.

The processor module 136 processes program routines to control the voice recognition module 182 and speech synthesis module 184 to allow interactive voice response (“IVR”) control of the VRO's functions. The program routines are stored on the memory/storage module 190 or stored at a location remote or external to the VRO 110. When using the voice recognition module 182, the telephone, when first picked up is disconnected from the telephone line by the switching module 140. One reason for disconnecting the telephone from the line is to disable a listening device which might have been placed on the telephone line. Additionally, with the telephone disconnected from the line, the voice dialer can be programmed from the telephone's keypad. Instead of being connected to the telephone line, the telephone is connected to the voice recognition module 182 and to the DTMF decoder module 144. The voice recognition module 182 will then respond to spoken commands such as “CONNECT” or “DIAL”, and the DTMF decoder 144 will respond to touch-tone commands. The voice commands used to program a number, look up a number, or dial a particular number are similar and are spoken when the VRO 110 is in ready mode. If the “CONNECT” word is spoken, or if the “#” key is depressed, then the switching module 140 reconnects the telephone to the telephone line to get a dial tone. The DTMF decoder module 144 and the voice recognition module 182 remain active and may or may not be used, depending on the desired VRO 110 function. After reconnecting to the dial tone, the “DIAL” command, along with the name of the person to dial, is spoken and the number is automatically dialed.

The voice recognition module 182 may also be used to make modifications to a phonebook database of numbers stored in the memory/storage module 190.

An incoming call announce program routine is processed by the processor module 136 and is useful for knowing who is calling. In addition to standard Caller ID, where the name and number of the calling party is displayed on the LCD of the Caller ID Module 186, a prerecorded name is also played back through the unit's speaker 185 depending on who is calling. Calling numbers that do not have speech records associated with them can be programmed with silence or with a voice recording that says “unknown caller”. The processor module 136 can also control the speech synthesis module 184 to read back the name according to what is shown on the LCD. The only caveat here is that what is read is limited by what is on the LCD. In the cases where names are incomplete on the LCD, they will also be incomplete when read back. In order to avoid this, the user can pre-record the announcements associated with each number.

The VRO 110 can perform many additional functions by using the processor module 136 to process program routines stored on the memory/storage module 190 or stored at a location remote or external to the VRO 110.

A call-logging feature makes a record of each call, made and received, in a database stored in the memory/storage module 190. The database includes the time and duration of each call. The database can then be download into a computer 132 through the port 134 or to a printer, for example. This call-logging feature is useful for printing out expense reports.

A toll call optimizer feature utilizes a database stored in the memory/storage module 190 to automatically determine the best carrier to use for each call. The database is also kept on a master server and is periodically transferred to the VRO's memory/storage module 190 via the PCMCIA or high-speed serial bus 192 or via the telephone jack 114 and modem 188. That way, the VRO is always up to date as to which carriers are the least expensive throughout the day.

A reminder database feature stores a database of calendar events in the memory/storage module 190. A time clock resident in the processor module 136 is always looking for scheduled events stored in the module 190 to occur. If the event is a reminder, the VRO 110 makes a phone call to a telephone number also in the reminder database and associated with that event to notify the person answering the call with a pre-recorded speech message (this message can either be one of the “stock” messages resident in the unit or can be recorded in the voice of the user).

An employee time clock feature provides a means for employees and vendors to log in periodically in order to keep track of time spent and completion of certain events. A user calls in to the VRO 110 and enters a user action code number, either verbally, in which case the voice recognition module 182 processes the number, or else using the telephone keypad, in which case the DTMF decoder module 182 interprets the tones. The VRO time stamps their entry and action code and stores the data in a database located in the memory/storage module 190. Upon request, the VRO prints out a report of the activity for a particular user code. This is a very useful feature for employers who wish to keep track of their employee's progress in certain situations (security guards, remote location check in, etc.), or for sales people and other entrepreneur types who need to keep a running tally of events.

A Caller ID forwarding feature forwards calls to another number based on the Caller ID of an incoming phone call. When the VRO receives an incoming call it uses the Caller ID information determined by the Caller ID module 186 and decides, based on a pre-programmed decision list stored in the memory/storage module 190, whether and where to forward the call. This feature is useful as a call dispatcher and log generator.

The VRO 110 also has Bluetooth capability, which allows it to transact with other devices without being physically connected by wires. Wireless transactions can take place as long as the VRO is in the same proximity as another Bluetooth device. This useful feature allows portable devices to upload/download information through the VRO 110 to the telephone lines without actually being physically connected.

The VRO 110 can be connected to BSR and X-10 interfaces for use with BSR and X-10. This application allows the use of any touch-tone telephone to control lights, computers, and anything else that can be plugged into the wall. BSR and X-10 are home and office automation standards. They are popular because the interface technology requires no wiring between the control unit and the plug-in modules that receive their signals through the power line to which they are plugged into. These plug-in modules are available at many electronic retail outlets and home automation mail-order houses. The VRO 110 can be used to send signals to these modules from a telephone. Any telephone connected to the VRO 110 can be used for tuning on computers, dimming lights, closing drapes, opening doors, etc.

To use the VRO's BSR/X10 interface, any phone connected to the VRO 110 can be picked up. Alternatively, the extension to which the VRO 110 is connected can be called from an outside extension. When receiving an outside call, the processor module 136 uses the DTMF decoder module 144 to listen for an appropriate 4-digit code to be entered on all incoming calls. If the DTMF decoder module 144 detects an appropriate 4-digit code during an incoming call, a voice menu prompts the caller for a command and the processor module 136 triggers the switching module 140 to disconnect the telephone line from all attached telephones. The outside caller or user of the attached telephone can then use voice or keypad commands to select the number of the light or appliance followed by it's command.

In the following examples the “*” and “#” keys on the telephone keypad are used to signal on and off, dim and bright. For example, if a driveway security light on module number 8 is to be turned on, the phone is picked up and “8**” is pressed. To dim the light slightly “8#” is pressed and the “#” is held to achieve the required dimness. To turn off an appliance attached to module 6, “6##” is pressed on the telephone touch pad.

The above-cited applications and number and symbol sequences are intended as illustrative examples only. Also, other hardware and functions can be used as determined by one skilled in the art. Accordingly, the invention is not limited to the precise embodiments described in detail hereinbefore.

We claim:

1. A portable and programmable telecommunications control and data storage device comprising:
a communications connection for transmitting telephonic communications between the telecommunications control and data storage device and an external communications network;
a portable housing containing a programmable processor, a storage device, and a switching module electrically connected between a telephonic terminal and the communications connection; and
multiple programs stored by the storage device, at least one of said programs executed by the processor to control the switching module to disconnect the terminal from the communications connection while maintaining the connection between the terminal and the telecommunications control and data storage device.

2. The telecommunications control and data storage device of claim 1, wherein:
at least some of the programs are periodically modified using updates received through a data connection.

3. The telecommunications control and data storage device of claim 2, wherein:
said updates are stored on a download server; and
the data connection is created between the download server and a modem used by the telecommunications control and data storage device.

4. The telecommunications control and data storage device of claim 1, wherein:
the terminal is disconnected from the communications connection to restrict incoming communications.

5. The telecommunications control and data storage device of claim 1, wherein:
the terminal is disconnected from the communications connection to restrict outgoing communications.

6. The telecommunications control and data storage device of claim 1, wherein:
at least one of said programs is executed by the processor to redirect incoming communications.

7. The telecommunications control and data storage device of claim 1, further comprising:
a port for transferring data between the storage device and a storage device external to the housing.

8. The telecommunications control and data storage device of claim 7, wherein:
the port transfers the data over the internet.

9. The telecommunications control and data storage device of claim 1, further comprising:
a port for linking the telecommunications control and data storage device to an external processor.

10. The telecommunications control and data storage device of claim 9, wherein:
the linking is over the internet.

11. The telecommunications control and data storage device of claim 1, wherein:
the external communications network is a public switched telephone network, and the communications connection is a telephone line of the public switched telephone network.

12. The telecommunications control and data storage device of claim 11, wherein:
when the switching module is not activated, the terminal is connected to an off-hook detection module and disconnected from any telephone line, and when the switching module is activated, the terminal is connected to the telephone line and disconnected from the off-hook detection module.

13. The telecommunications control and data storage device of claim 11, further comprising:
a line status detector module for indicating the status of the telephone line.

14. The telecommunications control and data storage device of claim 11, wherein:
a decoder module detects a touch tone code entered into the telephonic terminal causing the switching module to connect the telephone to the telephone line.

15. The telecommunications control and data storage device of claim 11, wherein:
a voice recognition module detects a spoken code entered into the telephone microphone causing the switching module to connect the telephonic terminal to the telephone line.

16. The telecommunications control and data storage device of claim 11, further comprising:
a data access arrangement for connecting the processor module to the public switched telephone network.

17. The telecommunications control and data storage device of claim 1, wherein:
the housing has a volume of less than one-third cubic meter.

18. The telecommunications control and data storage device of claim 1, wherein:
the VRO has a weight of less than one kilogram.

19. A method of using a telecommunications control and data storage device comprising the steps of:
picking up a telephone connected to the telecommunications control and data storage device but physically disconnected from any telephone line;
speaking a code or pressing a telephone keypad to enter a code to connect the telephone to a telephone line; and
upon connection to the telephone line, dialing an outside telephone number.

20. A method of using a telecommunications control and data storage device to redirect an incoming telephone call comprising the steps of:
attaching the telecommunications control and data storage device to an incoming line having a toll-free number;
dialing the toll-free number from a first extension;
entering a code from the outside extension for processing by a processor module of the telecommunications control and data storage device;
instructing the telecommunications control and data storage device to dial and connect to a second extension;
connecting the first extension to the second extension through the telecommunications control and data storage device to redirect the incoming telephone call.
